(19) United States
(12) Patent Application Publication
(10) Pub. No.: US 2012/0193235 A1
(43) Pub. Date: Aug. 2, 2012

(54) DNA MOTION CONTROL BASED ON NANOPORE WITH ORGANIC COATING FORMING TRANSIENT BONDING TO DNA

(75) Inventors: Ali Afzali-Ardakani, Ossining, NY (US); Stefan Harrer, Hampton (AU); Binquan Luan, Pleasantville, NY (US); Glenn J. Martyna, Croton on Hudson, NY (US); Hongbo Peng, Chappaqua, NY (US); Stephen M. Rossnagel, Pleasantville, NY (US); Ajay K. Royyuru, Congers, NY (US); Gustavo A. Stolovitzky, Riverdale, NY (US); Philip S. Waggoner, Fishkill, NY (US)

(73) Assignee: International Business Machines Corporation, Armonk, NY (US)

(21) Appl. No.: 13/359,743

(22) Filed: Jan. 27, 2012

Related U.S. Application Data
(60) Provisional application No. 61/437,106, filed on Jan. 28, 2011.

(51) Int. Cl. G01N 27/453

(52) U.S. Cl. 204/601

(57) ABSTRACT

A nanodevice includes a reservoir filled with a conductive fluid and a membrane separating the reservoir. The membrane includes an insulating layer. A nanopore is formed through the membrane, and an organic coating is provided on the insulating layer to form a transient bond to a DNA molecule in the nanopore. The transient bond is stronger than thermal motion, such that the transient bond can hold the DNA molecule against the thermal motion. When a voltage is applied across the membrane, the voltage will break the transient bond to move the DNA molecule through the nanopore in a controllable state.

### CROSS-REFERENCE TO RELATED APPLICATIONS

The application is based on and herein incorporates by reference the contents of U.S. Provisional Patent Application 61/437,106 filed on Jan. 28, 2011, and priority is claimed there from under applicable sections of 35 U.S.C. §119 or 120.

### BACKGROUND

Exemplary embodiments relate to nanodevices, and more particularly to motion control via transient bonding.

Nanopore sequencing is a method for determining the order in which nucleotides occur on a strand of deoxyribonucleic acid (DNA). A nanopore is a small hole in the order of several nanometers in internal diameter. The theory behind nanopore sequencing relates to what occurs when the nanopore is immersed in a conducting fluid and an electric potential (voltage) is applied across the nanopore. Under these conditions, a slight electric current due to conduction of ions through the nanopore can be measured, and the amount of current is very sensitive to the size and shape of the nanopore. If single bases or strands of DNA pass (or part of the DNA molecule passes) through the nanopore, this can create a change in the magnitude of the current through the nanopore. Other electrical or optical sensors can also be placed around the nanopore so that DNA bases can be differentiated while the DNA passes through the nanopore.

DNA could be driven through the nanopore by using various methods. For example, an electric field might attract the DNA towards the nanopore, and DNA might eventually pass through the nanopore. The scale of the nanopore means that the DNA may be forced through the hole as a long string, one base at a time, rather like thread through the eye of a needle.

### BRIEF SUMMARY

According to an exemplary embodiment, a nanodevice is provided. The nanodevice includes a reservoir filled with a conductive fluid, and a membrane separating the reservoir, where the membrane includes an insulating layer. The nanodevice includes a nanopore formed through the membrane, and an organic coating is provided on the insulating layer to form a transient bond to a molecule in the nanopore. The transient bond is stronger than thermal motion, such that the transient bond holds the molecule in place against thermal motion.

According to an exemplary embodiment, a system is provided. The system includes a nanodevice. The nanodevice includes a reservoir filled with a conductive fluid, and a membrane separating the reservoir, where the membrane includes an insulating layer. A nanopore is formed through the membrane, and an organic coating is provided on the insulating layer forming a transient bond to a molecule in the nanopore. The transient bond is stronger than thermal motion, such that the transient bond holds the molecule in place against thermal motion. A voltage source is configured to control motion of the molecule in the nanopore.

According to an exemplary embodiment, a nanodevice is provided. The nanodevice includes a substrate, and a nanochannel formed in the substrate. An organic coating is provided on an inside exposed surface of the nanochannel, and the organic coating forms a transient bond to a molecule in the nanochannel. The transient bond is stronger than a thermal motion, such that the transient bond holds the molecule against the thermal motion.

According to an exemplary embodiment, a system is provided. A nanodevice includes a substrate, and a nanochannel formed in the substrate. An organic coating is provided on an inside exposed surface of the nanochannel, and the organic coating forms a transient bond to a molecule in the nanochannel. The transient bond is stronger than a thermal motion, such that the transient bond holds the molecule against the thermal motion. The system includes a voltage source configured to control motion of the molecule in the nanochannel.

Other systems, methods, apparatus, design structures, and/or computer program products according to embodiments will be or become apparent to one with skill in the art upon review of the following drawings and detailed description. It is intended that all such additional systems, methods, apparatus, design structures, and/or computer program products be included within this description, be within the scope of the exemplary embodiments, and be protected by the accompanying claims. For a better understanding of the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features are apparent from the following detailed description taken in conjunction with the accompanying drawings in which:

FIG. 1 illustrates a schematic of a nanopore device in accordance with an exemplary embodiment.

FIG. 2 illustrates a schematic of a nanochannel device in accordance with an exemplary embodiment.

FIG. 3 illustrates example molecules of an organic coating according to an exemplary embodiment.

FIG. 4 illustrates a flow chart for motion control of a molecule according to an exemplary embodiment.

FIG. 5 illustrates a flow chart for motion control of a molecule according to an exemplary embodiment.

### DETAILED DESCRIPTION

Exemplary embodiments provide an organic coated nanopore and leverage the transient bonding between the organic coating and the DNA bases to control the motion of the DNA.

Recently, there has been growing interest in applying nanopores as sensors for rapid analysis of biomolecules such as deoxyribonucleic acid (DNA), ribonucleic acid (RNA), protein, etc. Special emphasis has been given to applications of nanopores for DNA sequencing, as this technology holds the promise to reduce the cost of sequencing below $1000/human genome. Two issues in nanopore DNA sequencing are to control the translocation (movement) of DNA through the nanopore and to differentiate DNA bases.

As discussed herein, exemplary embodiments utilize a nanopore coated with an organic layer, which can transiently bond to individual DNA bases and/or DNA backbones, and thus the DNA can be temporarily trapped inside the nanopore when enough of these transient bonds are present. The negatively charged DNA can be controllably driven through the nanopore by an external electrical field along the nanopore, and the electrical field can alternatively be tuned to be above and below the voltage threshold of breaking all transient bonds.

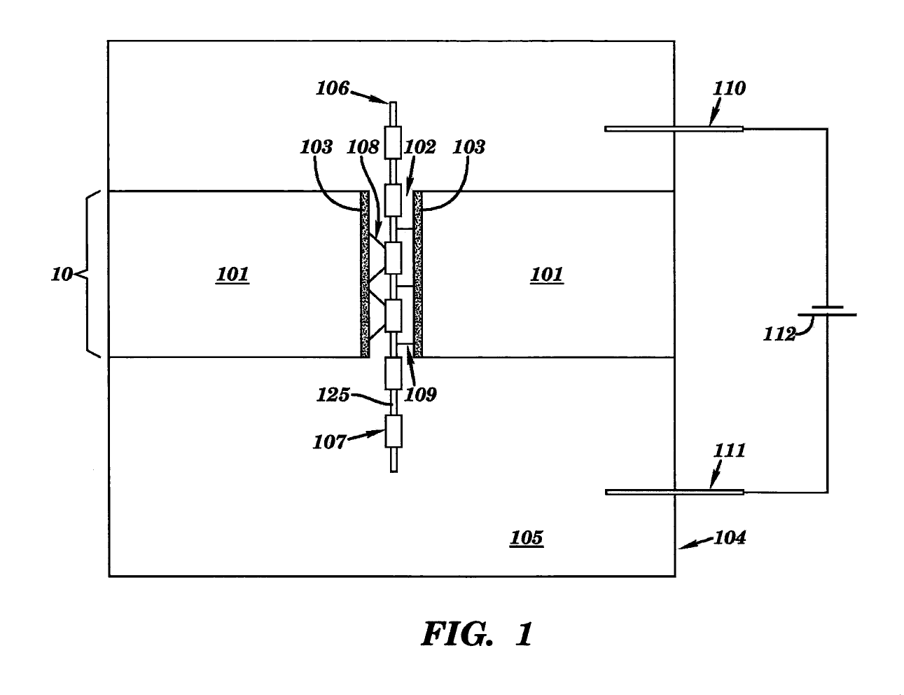

Now turning to FIG. 1, a schematic 100 is illustrated of a nanodevice with an organic coated nanopore for DNA motion control according to an exemplary embodiment. A membrane 10, which is made of a film (insulating layer 101), partitions reservoir 104 into two reservoir parts. FIG. 1 is a cross-sectional view of the reservoir 104. A nanometer size nanopore 102 is made through the insulating layer 101 of the membrane 10. The insulating layer 101 is a membrane part that is electrically insulating. The inside surface of the nanopore 102 is coated with organic coating 103. The reservoir 104 and the nanopore 102 are then filled with solvent 105 (a conductive solution). DNA molecule 106 (shown with DNA bases 107 and DNA backbones 125) is loaded into the nanopore 102 by an electrical voltage bias of the voltage source 112, applied across the nanopore 102 via two electrochemical electrodes 110 and 111, which were dipped in the solvent 105 of the two parts of reservoir 104. The organic coating 103 can be any organic coating that has/forms a transient bond 108, such as hydrogen bond, with individual DNA bases 107 and/or has/forms a transient bond 109 with DNA backbones 125. With a desired number of transient bonds (e.g., one or more), the DNA molecule 106 will be trapped inside the nanopore 102 against thermal agitation/motion. DNA molecule 106 is in an ionic solution/solvent 105 and each molecule of the ionic solution is at constant thermal motion, which will constantly bombard the DNA molecule 106. The energy of such thermal bombardment is k_{B}T, where k_{B} is Boltzmann's constant and T is absolute temperature. At room temperature, this energy is about 26 meV (megaelectron volts) or 4.2×10⁻²¹ J (joules). When the total bonding energy of the transient bonds (i.e., total of transient bonds 108 and/or 109) is much larger than 26 meV, the DNA molecule 106 will be trapped against the thermal bombardment and/or agitation of molecules in the ionic solution.

With a predefined voltage applied by voltage source 112, these transient bonds 108 and/or 109 can be broken and the negatively charged DNA molecule 106 can be driven through the nanopore 102 via the electrical field produced by the voltage source 112. If voltage of the voltage source 112 is pulsed, the DNA molecule 106 will experience a bonded phase (fixed in place) and a moving phase, and thus the motion of DNA molecule 106 is controlled (as desired). DNA molecule 106 can also be driven back and forth through the nanopore 102 many times by switching the polarity of the external voltage bias of voltage source 112, for repeated measurements. During the moving phase, the voltage is applied by the voltage source 112. During the bonded phase, no voltage is applied by the voltage source 112 but thermal motion would normally cause the DNA molecule 106 to move in the nanopore 102. However, the transient bonds 108 and/or 109 cause the DNA molecule 106 to be fixed (held) in place against the thermal motion or thermal agitation.

Although only one insulating layer 101 is shown in FIG. 1, exemplary embodiments are not limited to a single insulating layer 101. It is contemplated that additional layers 101 may be utilized to trap the DNA molecule 106 according to the principles discussed herein.

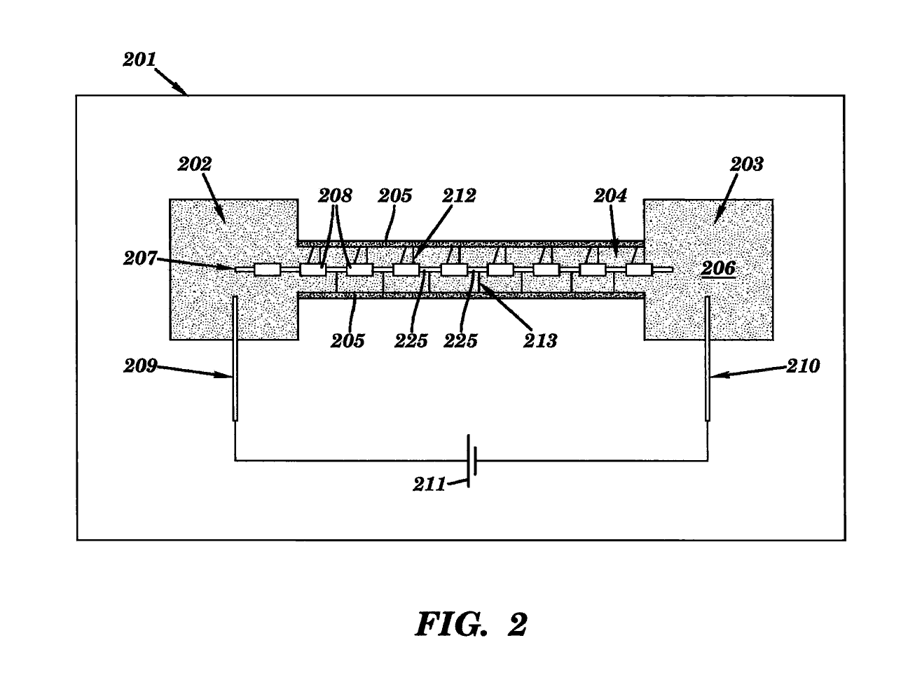

For some implementations of exemplary embodiments, the organic coating 103 (and correspondingly organic coating 205 in FIG. 2) can be monolayers which contain carboxylic acid exposed inside the nanopore 102, e.g., such as 4-carboxyphenylhydroxamic acid, which self assembles from its hydroxamic acid functionality on metal oxide and exposes the carboxylic acid functionality. Another example is a monolayer with phosphonic acid functionality exposed which can be achieved by phenylenediphosphonic acid. Both examples have a phenyl ring separating acid functionality and the nanopore surface (of insulating layer 101) inside the nanopore 102. Other functionalities for interaction with DNA molecule 106 are hydroxyl (from alcohols or phenols), carboxamides, sulfonamides and/or sulfonic acids, all of which form strong hydrogen bond with DNA molecule 106. Another class of self-assembled monolayers which can be used (as the organic coating 103) inside the nanopore 102 are those containing individual nucleotide bases like guanidine, adenine, thymine and cytosine. These bases can be derivatized in such a way that they form self assembly on metals like gold or platinum (thiol group) or metal oxide like titanium oxide, indium tin oxide etc. (phosphonic acid or hydroxamic acid functionality for self assembly).

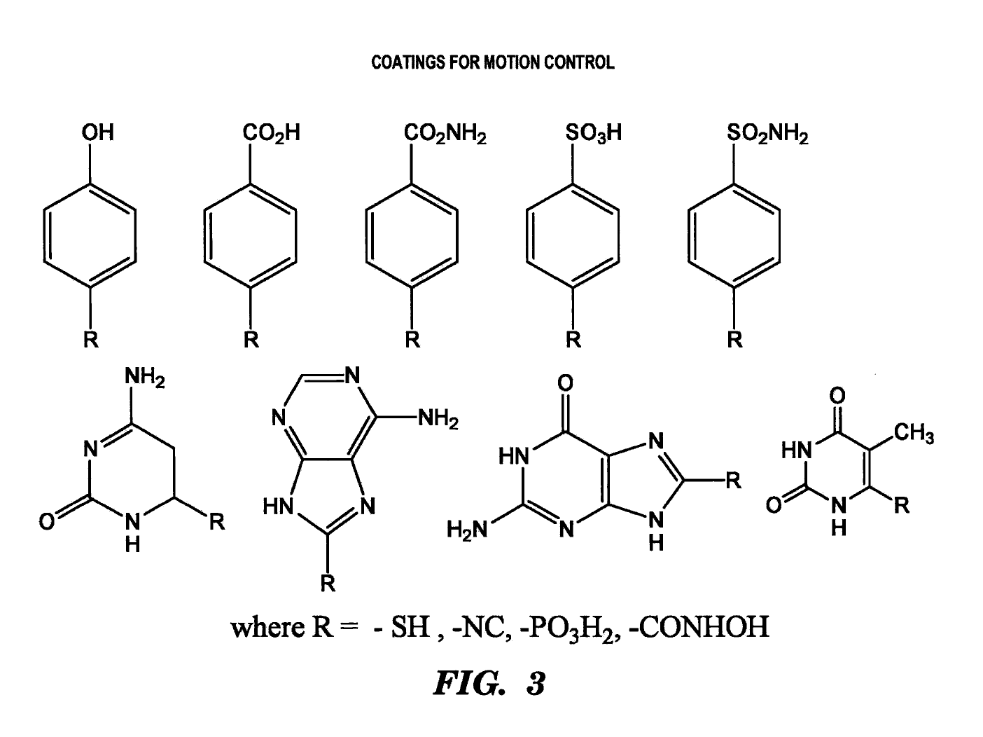

FIG. 3 illustrates examples of the organic coating 103 (and organic coating 205 in FIG. 2) according to an exemplary embodiment. The organic coatings 103 and 205 are designed for motion control as discussed herein. The examples of the organic coatings 103 and 205 are shown in FIG. 3 for illustration purposes as understood by one skilled in the art.

Now turning to FIG. 2, a schematic 200 is illustrated of a nanodevice according to an exemplary embodiment. FIG. 2 illustrates a “lateral nanochannel” version which is similar to FIG. 1. FIG. 2 is a top cross-sectional view of the schematic 200.

In the schematic 200, a substrate 201 may be made of any insulating/semiconductor solid material. Two reservoirs 202 and 203 are etched into the substrate 201, with a nanochannel 204 connecting the two reservoirs 202 and 203. The inside of the nanochannel 204 is then coated with organic coating 205. The reservoirs 202 and 203 and the nanochannel 204 are then filled with ionic solvent 206 (conductive solution). DNA molecules 207 (with DNA bases 208 and DNA backbone 225) are loaded into the nanochannel 204 by an electrical voltage bias of the voltage source 211, applied across the nanochannel 204 via two electrochemical electrodes 209 and 210, which were dipped in the ionic solvent 206 of the two reservoirs 202 and 203.

The organic coating 205 can be any organic coating that has/forms transient bonds 212, such as hydrogen bonds, with individual DNA bases 208 and/or has/forms transient bonds 213 with the DNA backbone 225. With a predefined number of transient bonds (e.g., sufficient transient bonds 212 and/or 213 to hold the DNA molecule), the DNA molecule 207 will be trapped inside the nanochannel 204 against thermal agitation/motion as discussed above.

For some implementations, the organic coating 205 can be monolayers which contain carboxylic acid exposed inside the nanochannel 204, e.g., 4-carboxyphenylhydroxamic acid which self assembles from its hydroxamic acid functionality on metal oxide and exposing the carboxylic acid functionality. Another example for organic coating 205 is a monolayer with phosphonic acid functionality exposed which can be achieved by phenylenediphosphonic acid. Both examples for organic coating 205 have a phenyl ring separating acid functionality and the nanochannel surface. Other functionalities (for organic coating 205) for interaction with DNA molecule 207 are hydroxyl (from alcohols or phenols), carboxamides, sulfonamides and sulfonic acids, all of which form strong hydrogen bonds with the DNA molecule 207. Another class of self-assembled monolayers which can be used inside the nanochannel 204 for the organic coating 205 are those containing individual nucleotide bases like guanidine, adenine, thymine and cytosine. These bases can be derivatized in such a way that they form self assembly on metals like gold or platinum (thiol group) or metal oxide like titanium oxide, indium tin oxide, etc. (phosphonic acid or hydroxamic acid functionality for self assembly).

With enough voltage (e.g., a predefined) applied by the voltage source 211, these transient bonds 212 and/or 213 can be broken, and the DNA molecule 207 can be driven through the nanochannel 204 via the electrical field produced by the voltage source 211. If the applied voltage of the voltage source 211 is pulsed, the DNA molecule 207 will alternate between the bonded phase and moving phase as discussed herein, and thus the motion of DNA molecule 207 is controlled. The DNA molecule 207 can also be driven back and forth through the nanochannel 204 many times by switching the polarity of the external voltage bias of the voltage source 211, for repeated measurements.

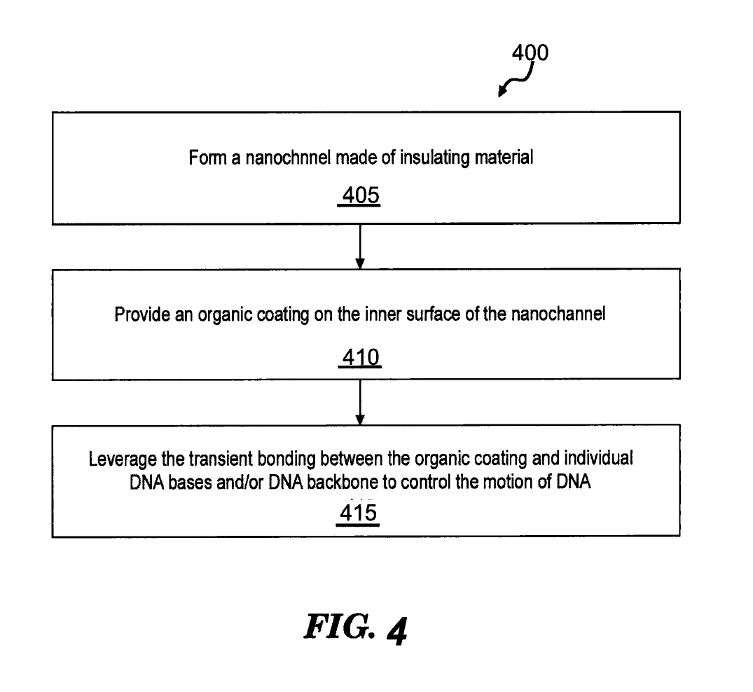

FIG. 4 illustrates a method 400 for controlling DNA molecules for DNA sequencing according to an exemplary embodiment, and reference can be made to FIG. 2.

At block 405, a nanochannel 204 is made of insulating material such as the substrate 201. The organic coating 205 is coated on the inner surface of the nanochannel 204 at block 410.

At block 415, the transient bonding 212 between the organic coating 205 and individual DNA bases 208 and/or the transient bonding 213 between the organic coating 205 and DNA backbones 225 are configured to control the motion of DNA molecule 207. The transient bond 212 and/or 213 is stronger than thermal motion, such that the transient bond holds the molecule against the thermal motion. When a voltage is applied across the nanochannel 204 by the voltage source 211, the voltage is configured to break the transient bond (i.e., to move the molecule through the nanochannel 204 in a controllable state. When a pulsed voltage is applied across the nanochannel 204 by the voltage source 211, the transient bond (e.g., transient bonds 212 and/or 213) alternatively breaks and bonds to the nanochannel 204 to move the DNA molecule 207 as desired.

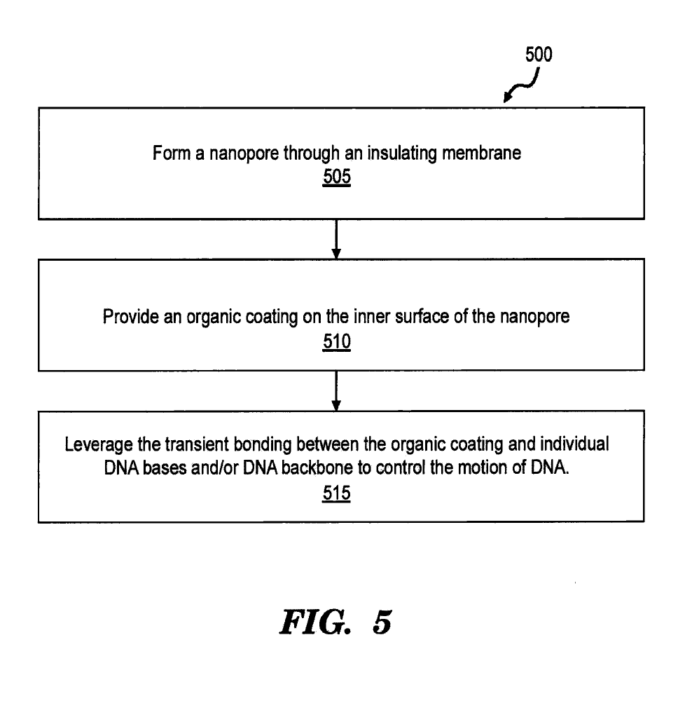

FIG. 5 illustrates a method 500 for controlling DNA molecules for DNA sequencing according to exemplary embodiments, and reference can be made to FIG. 1.

At block 505, a nanopore 102 is formed through an insulating membrane which is insulating layer 101. The organic coating 103 is coated on the inner surface of the nanopore 102, at block 510.

At block 515, the transient bonds 108 between the organic coating 103 (insulating layer 101) and the individual DNA bases 107 and/or transient bonds 109 between the organic coating 103 (insulating layer 101) and DNA backbones 125 are configured to control the motion of DNA molecule 106. The transient bond 108 and/or 109 is stronger than thermal motion, such that the transient bond holds the molecule in place against thermal motion. When voltage is applied across the membrane (insulating layer 101) by voltage source 112, the voltage is configured to break the transient bond to move the molecule through the nanopore 102 in a controllable state. When a pulsed voltage is applied across the membrane (insulating layer 101) by voltage source 112, the transient bond (transient bonds 108 and/or 109) alternatively breaks and bonds to the DNA molecule 106 to move the DNA molecule 106 as desired.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the exemplary embodiments of the invention have been described, it will be understood that those skilled in the art, both now and in the future, may make various improvements and enhancements which fall within the scope of the claims which follow. These claims should be construed to maintain the proper protection for the invention first described.

What is claimed is:

1. A nanodevice, comprising:
a reservoir filled with a conductive fluid;
a membrane separating the reservoir, the membrane comprising an insulating layer; and
a nanopore formed through the membrane, an organic coating provided on the insulating layer forming a transient bond to a molecule in the nanopore;
wherein the transient bond is stronger than a thermal motion, such that the transient bond holds the molecule in place against the thermal motion.

2. The nanodevice of claim 1, wherein when a voltage is applied across the membrane, the voltage is configured to break the transient bond to move the molecule through the nanopore in a controllable state.

3. The nanodevice of claim 1, wherein when a pulsed voltage is applied across the membrane, the transient bond alternatively breaks and bonds to the molecule.

4. The nanodevice of claim 1, wherein the transient bond is between the insulating layer and a base of the molecule.

5. The nanodevice of claim 1, wherein the transient bond is between the insulating layer and a backbone of the molecule.

6. The nanodevice of claim 1, wherein the transient bond is both between the insulating layer and a base of the molecule and between the insulating layer and a backbone of the molecule.

7. A system, comprising:
a nanodevice, comprising:
a reservoir filled with a conductive fluid;
a membrane separating the reservoir, the membrane comprising an insulating layer; and
a nanopore formed through the membrane, an organic coating provided on the insulating layer forming a transient bond to a molecule in the nanopore;
wherein the transient bond is stronger than a thermal motion, such that the transient bond holds the molecule in place against the thermal motion;
a voltage source configured to control motion of the molecule in the nanopore.

8. The system of claim 7, wherein, when a voltage of the voltage source is applied across the membrane, the voltage of the voltage source is configured to break the transient bond to move the molecule through the nanopore in a controllable state.

9. The system of claim 7, wherein, when a pulsed voltage of the voltage source is applied across the membrane, the transient bond alternatively breaks and bonds to the molecule.

10. The system of claim 7, wherein the transient bond is between the insulating layer and a base of the molecule.

11. The system of claim 7, wherein the transient bond is between the insulating layer and a backbone of the molecule.

12. The system of claim 8, wherein the transient bond is both between the insulating layer and a base of the molecule and between the insulating layer and a backbone of the molecule.

13. A nanodevice, comprising:
a substrate,
a nanochannel formed in the substrate;
an organic coating provided on an inside exposed surface of the nanochannel, the organic coating forming a transient bond to a molecule in the nanochannel;
wherein the transient bond is stronger than a thermal motion, such that the transient bond holds the molecule against the thermal motion.

14. The nanodevice of claim 13, wherein, when a voltage is applied across the nanochannel, the voltage is configured to break the transient bond to move the molecule through the nanochannel in a controllable state.

15. The nanodevice of claim 13, wherein, when a pulsed voltage is applied across the nanochannel, the transient bond alternatively breaks and bonds to the nanochannel.

16. The nanodevice of claim 13, wherein the transient bond is between the organic coating and a base of the molecule.

17. The nanodevice of claim 13, wherein the transient bond is between the organic coating and a backbone of the molecule.

18. The nanodevice of claim 13, wherein the transient bond is both between the organic coating and a base of the molecule and between the organic coating and a backbone of the molecule.

19. A system, comprising:
a nanodevice, comprising:
a substrate,
a nanochannel formed in the substrate; and
an organic coating provided on an inside exposed surface of the nanochannel, the organic coating forming a transient bond to a molecule in the nanochannel;
wherein the transient bond is stronger than a thermal motion, such that the transient bond holds the molecule against the thermal motion; and
a voltage source configured to control motion of the molecule in the nanochannel.

20. The system of claim 19, wherein, when a voltage is applied by the voltage source across the nanochannel, the voltage is configured to break the transient bond to move the molecule through the nanochannel in a controllable state.
